(19) United States
(12) Patent Application Publication
(10) Pub. No.: US 2024/0339693 A1
(43) Pub. Date: Oct. 10, 2024

(54) INTERCELL COOLING ELEMENT, BATTERY ARRANGEMENT, MOTOR VEHICLE, AND METHOD FOR PRODUCING AN INTERCELL COOLING ELEMENT

(71) Applicant: AUDI AG, Ingolstadt (DE)

(72) Inventors: Carsten LORENZ, Reichertshofen (DE); Eduard MAIN, Buxheim (DE)

(73) Assignee: AUDI AG, Ingolstadt (DE)

(21) Appl. No.: 18/602,193

(22) Filed: Mar. 12, 2024

(30) Foreign Application Priority Data
Apr. 5, 2023 (DE) 102023108732.0

(51) Int. Cl. H01M 10/6557; H01M 10/613; H01M 10/625; H01M 10/6567

(52) U.S. Cl. CPC H01M 10/6557; H01M 10/6567; H01M 10/613; H01M 10/625; H01M 2220/20

(57) ABSTRACT

An intercell cooling element for arrangement between two battery cells, which has a flexible outer shell which encloses an interior and which has a coolant supply connection and a coolant discharge connection. A first and opposite second outer side of the outer shell adjoin one another on outer edges of the outer shell. The intercell cooling element includes a spacer element arrangement which has at least two incompressible spacer element sections to provide a defined minimum distance between a first edge area of the first battery cell. and a second edge area of the second battery cell when the intercell cooling element is arranged between the first and second battery cells.

### FIELD

The invention relates to an intercell cooling element for arrangement between two battery cells, wherein the intercell cooling element has a flexible outer shell which encloses an interior, has a coolant supply connection for supplying a coolant into the interior, and has a coolant discharge connection for discharging a coolant from the interior, wherein the outer shell has a first outer side for arrangement on a first battery cell and a second outer side opposite to the first outer side for arrangement on a second battery cell, wherein the first and the second outer side adjoin one another on outer edges of the outer shell.

### BACKGROUND

Current cooling systems for battery modules or high-voltage batteries of motor vehicles usually use a relatively small area of the cells for cooling by positioning them below and/or above the cell, which is located in a cell assembly, for example a cell stack. Current lithium-ion cells also exhibit strong swelling behavior over their service life, subject to which the cells expand. This swelling behavior is due to aging and also due to the charging and discharging of the cells. When the cells are charged, the cells swell accordingly and contract again when discharged. For this purpose, materials are used in the module or in the cell stack, which is also referred to below as the cell stack, or in the overall system between the cells, which can absorb the swelling behavior by being compressed. Today, a conventional cooling plate is only partially able to compensate for such swelling behavior of the cells in the module or overall system. This means that the cells, the module, and possibly also the entire battery system are subjected to increasing forces. A flexible cooler between the cells, which can be provided, for example, by an intercell cooling element having a flexible outer shell, has advantages over this, since this provides an opportunity to adapt to the swelling behavior. However, in the course of such swelling, relatively large forces arise, which then act accordingly on such a flexible cooler. This poses the risk that the cooler will be completely compressed, causing the cooling to come to a standstill, or at least to be enormously reduced with respect to its cooling efficiency.

It would therefore be desirable to bring the discrepancy between a rigid cooler, which enables reliable cooling even with strong swelling forces, but cannot compensate for or absorb these forces, and a flexible cooler, which can absorb the swelling forces, but then under certain circumstances can no longer ensure efficient cooling, better into harmony.

WO 2020/221 856 A1 describes a pressure module for a battery cell, wherein the pressure module is an elastomeric component for swelling compensation with a simultaneous cooling or heating function for rechargeable batteries, and the pressure module has an outer shell made of a polymer material, which surrounds a cavity having a channel structure and connections for the inlet and outlet for the heat transfer medium are provided in the outer shell, wherein the outer shell has two opposing main surfaces which are connected to one another via their edges, wherein structural elements are provided on the inner surfaces which are arranged correspondingly to one another and in interaction define and stabilize the channel structure for the passage of the heat transfer medium. The structural elements can be designed in such a way that a free volume through which flow can occur remains even in the compressed state of the pressure module. The structures can be arranged on carrier plates within the outer shell. Stiffening can be achieved by the carrier plates.

This means that a certain flow can still be guaranteed in the compressed state, but this in turn is accompanied by a certain stiffening of the pressure module, which in turn reduces the ability to absorb swelling forces. This also complicates the construction of such a cooler enormously.

### SUMMARY

The object of the present invention is therefore to provide an intercell cooling element, a battery arrangement, a motor vehicle, and a method which make it possible to ensure an ability to flow through the intercell cooling element even under strong swelling forces and at the same time ensure good geometric adaptability of the intercell cooling element to the swelling behavior of the adjoining battery cells in the simplest and most efficient way possible.

This object is achieved by an intercell cooling element, a battery arrangement, a motor vehicle, and a method.

An intercell cooling element according to the invention for arrangement between two battery cells has a flexible outer shell which encloses an interior, has a coolant supply connection for supplying a coolant into the interior, and has a coolant discharge connection for discharging a coolant from the interior. Furthermore, the outer shell has a first outer side for arranging a first battery cell and a second outer side opposite to the first outer side for arranging a second battery cell, wherein the first and the second outer side adjoin one another at outer edges of the outer shell. The intercell cooling element comprises a spacer element arrangement which has at least two incompressible first spacer element sections for providing a minimum distance defined by a thickness of the first spacer element sections between a first edge area of the first battery cell and a second edge area of the second battery cell when the intercell cooling element is arranged between the first and the second battery cell, wherein one of the at least two first spacer element sections is arranged on at least two first outer edges of the outer shell of the intercell cooling element that are opposite to one another with respect to a first direction.

The invention is based on the knowledge that the swelling of battery cells is extremely low, especially in their edge areas in relation to the cell sides facing each other in a cell stack, and that the battery cells bulge particularly strongly in the course of swelling especially in a central area in relation to the cell sides facing toward one another in a cell stack. This knowledge is now used to design the intercell cooling element differently in some areas, that is, especially with regard to its compressibility. In a central area of the intercell cooling element, in which the spacer element arrangement is thus not arranged, a particularly high level of flexibility, geometric adaptability, and compressibility can be provided by the flexible outer shell, so that advantageously the intercell cooling element is very well adaptable to the battery cells bulging in the central area. Swelling forces can accordingly be absorbed very well and do not result in overstressing of the cells in this central area, since the intercell cooling element is designed to be very flexible especially in this central area. In contrast, the spacer element arrangement, which is arranged in the area of the outer edges, i.e. outside the outer shell, in particular at least two opposing first outer edges of the outer shell, and which is incompressible, can now advantageously ensure that the cells are always at a certain minimum distance, at least in this edge area. In the central area of the cells, where they bulge more than in the edge area, this distance can certainly be smaller, but it can still be adjusted via the thickness of the incompressible spacer element sections so that a certain minimum distance is also still ensured in the central area of the cells where the swelling behavior is most pronounced. This can then advantageously also ensure the ability to flow through the very flexible, yielding outer shell at the same time. Since the spacer element sections are not arranged in the central area but in the edge area, that is to say on the at least two opposing first outer edges of the outer shell, and, based on their intended installation position in a battery module, accordingly only come into contact in the edge areas of the first and second battery cells, no high swelling forces act on the spacer element sections themselves. The incompressible spacer element sections therefore do not result in mechanical stress on the battery cells due to the swelling forces that occur, since these mainly come to bear in the central area of the cells, where the intercell cooling element is yielding and flexible due to its flexible outer shell. Thus, overall, an intercell cooling element can be provided which, on the one hand, is sufficiently flexible to adapt to the swelling behavior of the battery cells, and in which the incompressible spacer element sections ensure that a coolant can still flow through by the interior within the flexible outer shell even in the event of strong cell swelling.

The fact that the outer shell encloses the interior is to be understood to mean that the interior does not have to be completely fluidically sealed, but only insofar as two fluidic accesses to this interior are provided by the two connections, namely the coolant supply connection and the coolant discharge connection. The interior can therefore be completely enclosed by the outer shell except for the two points at which the connections are arranged. A coolant supply line and a coolant discharge line of the motor vehicle can accordingly be connected to these connections. This advantageously allows a coolant, preferably a liquid coolant, to be supplied to the intercell cooling element, in particular its flexible outer shell, and discharged from it again. The interior of the outer shell is therefore designed to allow the coolant to flow through it.

The fact that the outer shell is flexible does not necessarily imply that it is also elastic, although this can still be the case. However, the flexibility of the outer shell is preferably provided by a particularly thin design of this outer shell, that is to say the design of the outer shell with a particularly small wall thickness, which is dimensioned such that the fluid pressures that occur during operation can be withstood. The wall thickness of the outer shell can, for example, be in the range of a few millimeters or micrometers. The flexible outer shell can be designed like a bag, for example. The geometry of the outer shell can, for example, correspond to a geometry of a lateral surface of a battery cell that faces toward another lateral surface of an adjacent battery cell in a cell stack. The geometry of the outer shell can also be designed differently. For example, the outer shell can also protrude slightly laterally from the cell assembly in order to be able to connect the coolant supply line and coolant discharge line there more easily to the corresponding connections of the intercell cooling element. In particular, the coolant supply connections and the coolant discharge connections of multiple intercell cooling elements arranged adjacent in a cell stack can also be fluidically coupled or connected to one another. However, at least one height or one width of the outer shell preferably corresponds to a height or width of the first or second battery cell. This makes it possible to ensure that the spacer element sections described, which are arranged on the opposing first outer edges of the outer shell, also come to rest in an edge area of these battery cells. If the intercell cooling element is arranged as intended in a cell stack with multiple battery cells arranged adjacent to one another in a stacking direction, the above-mentioned first direction is preferably perpendicular to the stacking direction. The edges of the outer shell delimit the outer shell in the first direction, namely the first outer edges, as well as in a second direction perpendicular to the first, which is also perpendicular to the stacking direction. These edges can be referred to as second outer edges, as explained in more detail below.

In a further advantageous embodiment of the invention, the two first spacer element sections are designed as two non-contiguous, separate first spacer bars. The spacer element sections can therefore be provided as elongated spacer elements in the form of first spacer bars. These can extend in particular over the entire length of the respective first outer edges, in particular uninterrupted, or optionally also with interruptions. According to a further advantageous embodiment of the invention, these two spacer bars can also be the only spacer sections that are comprised by the spacer element arrangement. In other words, the spacer element arrangement can consist of these two spacer bars. Especially in this case or also in general, it is furthermore very advantageous if none of the spacer element sections are arranged on two second outer edges of the outer shell that are opposite to one another with respect to a second direction and/or the coolant supply connection and the coolant discharge connection are arranged on at least one of the two second outer edges or in at least one of two edge areas of the outer shell, which adjoin the two second outer edges. Especially at the edge areas of the outer shell, where the above-mentioned spacer bars are not arranged, the coolant supply and discharge lines can be arranged particularly easily on the coolant supply and discharge connections.

Alternatively, it is also conceivable that the coolant supply and discharge connections are led out through openings or recesses in these spacer bars. This also makes it possible, for example, to design the spacer element arrangement as a kind of frame around the outer shell or along the outer shell edges.

In general, it represents a further advantageous embodiment of the invention if the spacer element arrangement is composed of bar-shaped spacer element sections which, in addition to the first spacer element sections, comprise at least two second incompressible spacer element sections which are arranged on two second outer edges of the outer shell which are opposite to one another with respect to a second direction, wherein the spacer element arrangement has at least one through opening or interruption through which the coolant supply connection and the coolant discharge connection are led to the outside. It is preferred that the coolant supply connection is arranged at a certain distance from the coolant discharge connection. Accordingly, it is advantageous if the spacer element arrangement has not only one such through opening, but two through openings or interruptions, through which, on the one hand, the coolant supply connection and, on the other hand, the coolant discharge connection are led to the outside. The spaced arrangement of the connections enables more efficient flow through the interior of the outer shell. In this case, spacer bars can be arranged not only on the first outer edges of the outer shell, but also on the second outer edges of the outer shell. In this case, it is also preferred that both the first outer edges and the second outer edges of the outer shell extend in a straight line and in particular also represent the only outer edges of the outer shell. If, on the other hand, the spacer element arrangement only has two spacer bars which are arranged on the first outer edges of the outer shell, the second outer edges of the outer shell can be designed differently in terms of their geometry, that is to say, they do not necessarily have to extend in a straight line, but can also extend bent. In this case, the outer edges of the outer shell can define a hexagonal geometry of the outer shell.

By bending the second outer edges outward in this way, for example, the intercell cooling element can protrude laterally from a cell assembly. The connections for the coolant can be arranged at these protruding points.

In a further advantageous embodiment of the invention, the outer shell is formed from at least one film. In principle, both a plastic film and a metal foil are suitable, wherein a metal foil is preferred because it has better thermal conductivity. A film is particularly thin and enables the outer shell to be designed flexibly in a particularly simple manner. The outer shell can, for example, be provided from a folded film, which are joined together at the edges, except at the folding edge, or the outer shell can also be provided from two overlaid films which are joined together in the edge area to provide the edges, for example, are glued together or welded. Other connection technologies are also conceivable, such as crimp connections or the like. There is no need to connect the films at two points in the edge area in order to integrate the connections mentioned at these points. There the film edges can be joined or connected accordingly, for example, to connecting pieces that provide the connections, in particular in a fluid-tight manner. Due to the spacer element arrangement, in which the outer edges can be clamped, for example, or accommodated with a type of clamp enclosure or enclosed by the spacer element sections, it is also possible to exert pressure on both sides via the spacer element arrangement on the outer edges in the intended installed state in a battery module. This additionally stabilizes the joint on the outer edges and, for example, seals them additionally.

In a further advantageous embodiment of the invention, the spacer element arrangement is formed from or comprises a plastic or a fiber-reinforced plastic. A plastic has electrically insulating properties at the same time, which ensures greater safety in connection with battery modules. In addition, the spacer element arrangement can be manufactured particularly casily in this way, for example in an injection molding process, and it can also be designed having an extremely low weight.

In a further advantageous embodiment of the invention, the intercell cooling element comprises at least one buffer element arranged in the interior to provide a second minimum distance, defined by a second thickness of the buffer element, between a first central area of the first battery cell and a second central area of the second battery cell when the intercell cooling element is arranged between the first and second battery cells. Such a central area lies between the edge areas of the first and second battery cells in relation to the first direction defined above. Advantageously, at least one buffer element can also be integrated in the interior of the outer shell in order to also ensure a certain minimum distance in relation to the first direction in the central area of the outer shell if necessary. If the outer shell is compressed very strongly in the stacking direction of the cell stack in which it is arranged, this buffer element can ensure that an area through which flow can occur still remains in the interior of the outer shell. The buffer element can be designed in different ways, for example as a local buffer element, which is arranged on an inside of the outer shell and does not normally contact the opposite inner side of the outer shell, but only when the distance between the opposite sides of the outer shell falls below a specific distance. Multiple such buffer elements can also be arranged distributed in the interior on the inner sides of the outer shell. The buffer elements can also be designed to be strong and incompressible, or, preferably, also compressible. As a result, the buffer elements provide further flexibility, which is protective of the battery cells. The second minimum thickness can then be defined by the thickness of the buffer element in the maximally compressed state.

The one or more buffer elements can, in relation to the first direction, be arranged, for example, only in a central area of the outer shell or its interior or can extend over the entire interior in the first direction and/or a second direction perpendicular thereto. The buffer elements or the buffer element arrangement can also be designed differently in the central area and in an edge area. It is also conceivable that the buffer element arrangement or the at least one buffer element is provided as a type of 3D lattice structure. The three-dimensionality of such a lattice structure still ensures that flow can pass through. The lattice structure can also provide a certain degree of compressibility, for example by shifting the sides of the structural elements relative to one another. By such a buffer element, the intercell cooling element can be given additional stability in order to ensure the ability to flow through without impairing the elasticity and compressibility.

Furthermore, the invention also relates to a battery arrangement having at least two battery cells and an intercell cooling element according to the invention or one of its embodiments. The advantages described for the intercell cooling element according to the invention and its embodiments thus apply similarly to the battery arrangement according to the invention. In addition, the intercell cooling element can be arranged between the two battery cells, as already described in connection with the intercell cooling element and its embodiments.

The battery cells can be provided as lithium-ion cells, for example. The battery arrangement can be designed, for example, as a battery module. Such a battery module can in turn have multiple battery cells arranged adjacent to one another in a stacking direction, which are thus provided as a cell stack. An intercell cooling element according to the invention or one of its embodiments is preferably arranged between each two battery cells arranged adjacent in the stacking direction. A coolant supply line can be arranged at the respective coolant supply connections of the intercell cooling elements. A common coolant supply line having multiple branch points can be provided for all of the intercell cooling elements comprised by the battery arrangement. This applies accordingly to a coolant discharge line and the corresponding coolant discharge connections of the intercell cooling elements. In addition, the battery cells can be designed, for example, as pouch cells or prismatic battery cells.

A high-voltage battery for a motor vehicle having a battery arrangement according to the invention or one of its embodiments should also be regarded as included in the invention. Such a high-voltage battery can in particular have multiple battery modules which are designed like the battery arrangement.

Furthermore, the invention also relates to a motor vehicle having a battery arrangement according to the invention or one of its embodiments.

The motor vehicle according to the invention is preferably designed as an automobile, in particular as a passenger car or truck, or as a passenger bus or motorcycle.

Furthermore, the invention also relates to a method for producing an intercell cooling element for arrangement between two battery cells, wherein the intercell cooling element is provided which has a flexible outer shell which encloses an interior, has a coolant supply connection for supplying a coolant into the interior, and has a coolant discharge connection for discharging a coolant from the interior. Furthermore, the outer shell comprises a first outer side to be arranged on a first battery cell and a second outer side opposite to the first outer side to be arranged on a second battery cell, wherein the first and the second outer side adjoin one another at outer edges of the outer shell. At least two incompressible spacer element sections are provided to provide a minimum distance, defined by a thickness of the first spacer element sections, between a first edge area of the first battery cell and a second edge area of the second battery cell when the intermediate cell cooling element is arranged between the first and second battery cells on at least two opposite, first outer edges of the outer shell of the intercell cooling element. The advantages mentioned for the intercell cooling element according to the invention and its embodiments thus also apply similarly to the method according to the invention.

According to a further advantageous embodiment, the at least two incompressible first spacer element sections are provided on the at least two opposing first outer edges of the outer shell in that the first spacer element sections are injected onto the at least two first outer edges in an injection molding process at the first outer edges.

The same can also apply to the optional further spacer element sections described above.

According to a further advantageous embodiment of the invention, the first spacer element sections are designed in two parts and each have a first and second section part, wherein the first spacer element sections are provided on the now two opposing first outer edges of the outer shell in that one of the now two opposing first outer edges is in each case arranged between a first and second section part and in particular is clamped between them. In addition, the two section parts having the corresponding first outer edge located between them can also be joined together, for example glued together or welded.

In both cases, a particularly stable bond can be provided between the spacer element sections and the outer shell at its edges. In addition, by clamping and arranging the intercell cooling element between two battery cells, additional contact pressure is exerted on these spacer element sections by the battery cells in the edge area. The edges of the outer shell surrounded by the spacer element sections are thus additionally clamped or stabilized by this contact pressure. This can also stabilize a joint in the edge area of the outer shell.

Both production and arrangement variants described allow a particularly simple and cost-effective arrangement of the spacer element sections on the outer shell. This also applies in particular to a frame-shaped design of the arrangement of the spacer element sections.

The invention also includes refinements of the method according to the invention, which have features as already described in the context of the refinements of the intercell cooling element according to the invention and the battery arrangement according to the invention. For this reason, the corresponding refinements of the method according to the invention are not described again here.

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic and perspective representation of an intercell cooling element, arranged on a battery cell, according to an exemplary embodiment of the invention;

FIG. 2 shows a schematic and perspective representation of an intercell cooling element, arranged on a battery cell, according to a further exemplary embodiment of the invention;

FIG. 3 shows a schematic cross-sectional representation of a battery arrangement having an intercell cooling element arranged between two cells in a state not filled with cooling liquid, according to an exemplary embodiment of the invention;

FIG. 4 shows a schematic cross-sectional representation of a battery arrangement having an intercell cooling element arranged between two battery cells and comprising a preformed outer shell, according to an exemplary embodiment of the invention;

FIG. 5 shows a schematic cross-sectional representation of a battery arrangement having an intercell cooling element located between two swelled cells in a state filled with a coolant according to an exemplary embodiment of the invention;

FIG. 6 shows a schematic cross-sectional representation of a central area of the intercell cooling element having integrated buffer elements according to an exemplary embodiment of the invention;

FIG. 7 shows a schematic representation of a central part of the intercell cooling element having a lattice structure integrated in the interior of the outer shell, according to a further exemplary embodiment of the invention;

FIG. 8 shows a schematic cross-sectional representation of a part of the intercell cooling element in the area of a spacer element section, which is designed as an extrusion coating around the edge of the outer shell, according to an exemplary embodiment of the invention; and

FIG. 9 shows a schematic cross-sectional representation of a part of the intercell cooling element in the area of a spacer element section, which is formed in two parts, according to a further exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

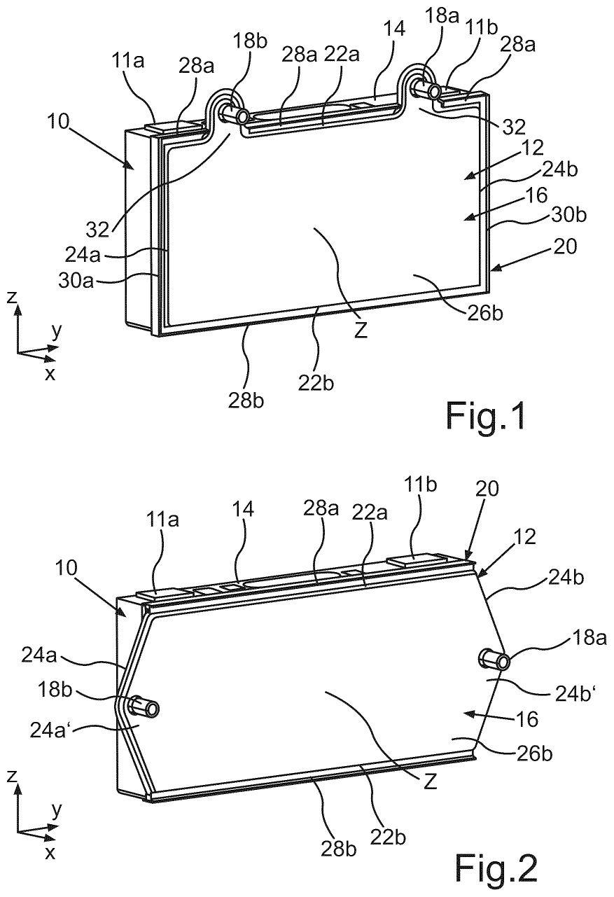

FIG. 1 shows a schematic representation of an intercell cooling element 12, arranged on a battery cell 10, according to an exemplary embodiment of the invention. The battery cell 10 is designed as a prismatic battery cell. The battery cell 10 also comprises two cell poles 11a, 11b, which in this example are arranged on an upper side 14 of the battery cell. In principle, however, these can be arranged on any side of the battery cell 10, in particular also on different sides of the battery cell 10, for example on opposite sides of the battery cell 10. The largest side of the battery cell 10 in terms of area represents the one on which the mentioned intercell cooling element 12 is to be arranged and is arranged in this example. In relation to an intended installation position in a battery module, the intercell cooling element is arranged between two such battery cells 10, and thus contacts the largest cells of the battery cells 10 in terms of area on both sides. This means that very large areas of the battery cells 10 can be cooled within a battery module.

The intercell cooling element now has, on the one hand, a flexible outer shell 16. This surrounds an interior through which a coolant can flow. For supplying such a coolant, the intercell cooling element 12 comprises two connections 18a, 18b, one of which is designed as a coolant supply connection and the other as a coolant discharge connection. At one of the connections 18a, 18b, during normal operation of the battery module comprising the intercell cooling element 12, a coolant supply line is arranged at the coolant supply connection, for example the first connection 18a, and a corresponding coolant discharge line is arranged at the second connection 18b and the coolant can be supplied via these connections to the intercell cooling element 12 and discharged from it again.

As the battery cells 10 age and also when charging and discharging the battery cells 10, such battery cells 10 begin to swell. The flexible outer shell 16 now makes it possible to absorb the swelling forces or to allow expansion of the cells 10 by yielding of the outer shell 16 or of the intercell cooling element 12 in a central area Z. In order to prevent the intercell cooling element 12 from being flattened in such a way that flow through of the coolant is no longer possible, a spacer element arrangement 20 is now advantageously provided, which in this example is designed as a frame-shaped spacer element arrangement 20.

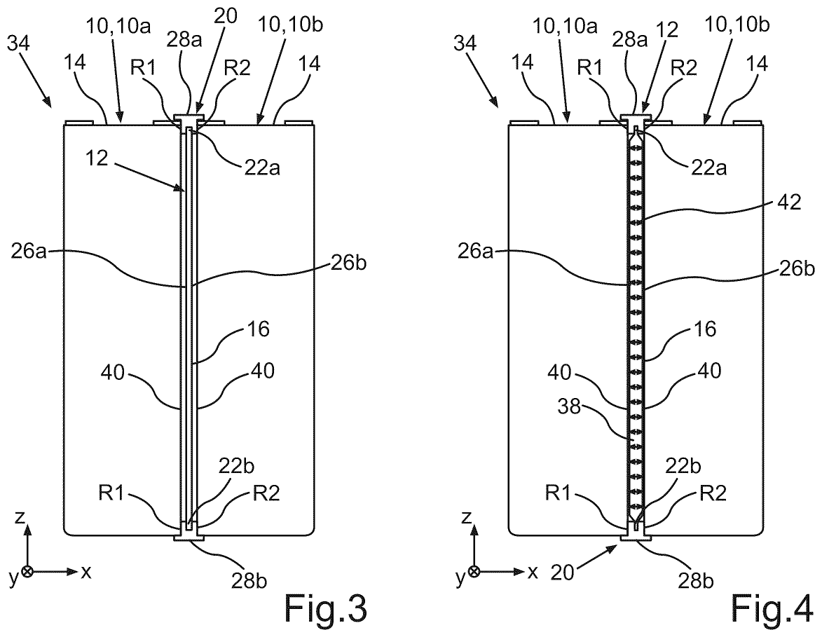

In general, the outer shell 16 has outer edges 22a, 22b, 24a, 24b, on which the two outer sides 26a (cf. FIG. 3), 26b adjoin one another and are joined together, for example welded, at least up to the area in which the supply and discharge connections 18a, 18b are arranged. The outer shell 16 may generally be provided, for example, by a folded metal foil or two metal foils joined together.

The spacer element arrangement 20 now has multiple first spacer elements, in particular multiple incompressible first bar-shaped spacer element sections 28a, 28b, which are arranged on the respective outer edges 22a, 22b, which lie opposite to one another with respect to the z direction shown. The lower first spacer element section 28b is designed to be straight and made in one piece. The upper spacer element section 28a, which is arranged on the upper first edge 22a in the illustration in FIG. 1, is designed to be interrupted, but also extends in a straight line. In particular, this first spacer element section 28a or the multiple first upper spacer element sections 28a has two interruptions 32 in their entirety, through which the supply and discharge connections 18a, 18b or one of the supply and discharge connections 18a and 18b are led out. In addition, the outer shell 16 comprises two second outer edges 24a, 24b, which are opposite with respect to the y-direction and on each of which a bar-shaped second spacer element section 30a, 30b extending in a straight line is also arranged. These first and second spacer element sections 28a, 28b, 30a, 30b can therefore be understood as sections of the same spacer element, which is provided by the spacer element arrangement 20. In other words, the individual spacer element sections can optionally also be connected to one another. However, they can also be separated from one another, such as in the example of the middle upper first spacer element section 28a, which is separated from the remaining sections 28a in the upper area by the recesses 32.

These sections 28a, 28b, 30a, 30b are preferably manufactured from a plastic material. They are also incompressible and designed to be as rigid as possible.

FIG. 8 shows, for example, a schematic cross-sectional representation of a battery arrangement 34 or a part thereof in the area of such a spacer element section 28a. This has a thickness D, which at the same time also defines a minimum distance M between a first edge area R1 of a first battery cell 10a, which can be designed like the battery cell 10 in FIG. 1, and a second edge area R2 of a second battery cell 10b, which also can be designed like the battery cell 10 from FIG. 1. As can also be seen in this example, the upper edge 22a of the outer shell 16 is clamped or enclosed by the spacer element section 28a. In this example, the spacer element section 28a is molded onto the edge 22a and is therefore made in one piece. In addition, the spacer element section 28a in this example comprises a support flange 36, which rests on both sides on the top sides 14 of the adjoining cells 10a, 10b. Such a support flange 36, in which the spacer element 28a is widened in relation to the part having the thickness D located between the two cells 10a, 10b, can provide a positioning aid in the production of such a battery module 34 or such a battery arrangement 34. This flange 36 is merely optional. Due to the contact pressure force that the cells 10a, 10b exert on the intercell cooling element 12, a stable bond is achieved during operation or in the finished module 34, even without such a support flange 36. In this example, the interior 38 enclosed by the outer shell 16 can also be seen in particular.

The further first spacer element 28b or the further first spacer element section 28b, as shown in FIG. 1, as well as the optional further second spacer element sections 30a, 30b can be designed as described for the first spacer element section 28a and shown in FIG. 8. All of them have a thickness D in the area that is arranged between two cells 10a, 10b, which is the same for all spacer element sections 28a, 28b, 30a, 30b. This thickness D is defined in particular with respect to the x direction shown.

Due to this embodiment having a spacer element arrangement 20, which comprises incompressible spacer element sections, it is now advantageously possible to keep the cells 10a, 10b at least in their edge areas R1, R2 at a defined minimum distance M, which the distance cannot fall below. This relieves the flexible outer shell 16 in the central area Z. The central area Z can define an area around the middle of the intercell cooling element 12 with respect to the y and/or z direction or the entire area up to the edges 22a, 22b, 24a, 24b or up to the beginning of the spacer element sections 28a, 28b, 30a, 30b arranged on these edges.

FIG. 2 shows a schematic representation of an intercell cooling element 12, arranged on a battery cell 10, according to a further exemplary embodiment of the invention. This or the entire arrangement can be designed as described above, except for the differences described below. These essentially consist of the geometry of the second outer edges 24a, 24b of the intercell cooling element 12 or its outer shell 16, which in this example are not designed to extend in a straight line, but are designed to be angled outwards, so that a width of the intercell cooling element 12 in the y direction is greater than that of the cell 10. The intercell cooling element 12 therefore projects laterally, in this example on both sides, beyond the cell 10. Another difference is the arrangement of the supply and discharge connections 18a, 18b, which are now arranged in the area of these protruding sections or the edge areas 24a′, 24b′ of the intercell cooling element 12 or its outer shell 16 adjoining the second outer edges 24a, 24b. The first spacer element sections 28a, 28b, which in the present case are again designed in the form of a bar and again extend in a straight line and are arranged on the first outer edges 22a, 22b of the outer shell 16 extending in a straight line, can now advantageously both be embodied without any interruption 32 (see FIG. 1). In addition, the spacer element arrangement 20 in the present case is not frame-shaped, but only comprises these two first spacer element sections 28a, 28b, which both extend over the entire length of the associated first outer edges 22a, 22b on which they are arranged. The second outer edges 24a, 24b, in contrast, are designed without such spacer element sections.

Furthermore, the intercell cooling elements 12 can be designed in the area of their connections 18a, 18b in such a way that the connection ends, shown open here, which therefore face away from the outer shell 16 and point in the direction of the cell 10 arranged closest adjacent (not shown here), are connectable to the intercell cooling element 12 closest in the x direction, in particular in corresponding connection areas 18a, 18b. The connection areas 18a, 18b can therefore be provided on the rear side with openings into which the connections 18a, 18b of a further intercell cooling element 12 can be inserted. Appropriate seals, such as O-rings or the like, can be used for sealing. Corresponding supply and discharge lines can be connected to the first or last intercell cooling element 12 of a cell assembly. As a result, all intercell cooling elements 12 of this composite can be equally supplied with coolant or coolant can be discharged therefrom.

Furthermore, there are different design options for the outer shell 16. This can in particular be preformed or not preformed.

FIG. 3 shows a schematic cross-sectional representation of a battery arrangement 34 having two battery cells 10a, 10b, between which an intercell cooling element 12 is arranged, which comprises a non-preformed outer shell 16, in particular in a state not filled with a coolant, according to an exemplary embodiment of the invention. The intercell cooling element 12 and in particular the entire battery arrangement 34 can also be designed as described above, that is to say, the intercell cooling element 12 can, for example, correspond to that from FIG. 1 or that from FIG. 2. The outer shell 16 is formed, for example, by film inserts inserted into the spacer elements or spacer element arrangement 20, which are not preformed. The film inserts that provide the outer shell 16 enable elastic expansion of the outer shell 16 when filled with the coolant and when pressure builds up due to the filled coolant. If coolant is decanted into the interior 38 (cf. FIG. 8) via one of the connections 18a, 18b (cf. FIGS. 1 and 2), the outer shell 16 expands accordingly and clings to the facing cell sides 40 of the battery cells 10a, 10b. The defined distance M (cf. FIG. 8) at least in the edge area R1, R2 of the respective sides 40 of the cells 10a, 10b is again ensured via the spacer element sections 28a, 28b, as described above, and the optional second spacer element sections 30a, 30b (not shown in the present case).

In the unexpanded state of the outer shell 16, a certain distance thus remains between the outer sides 26a, 26b of this outer shell 16 and the facing sides 40 of the adjacent battery cells 10a, 10b. Only when the battery arrangement 34 is in operation, i.e., when the interior 38 of the intercell cooling element 12 is filled with the coolant, are the outer sides 26a, 26b also clinging to the cell sides 40.

FIG. 4 shows a schematic cross-sectional illustration of a battery arrangement 34 according to another exemplary embodiment of the invention. This can be designed in particular as in FIG. 3, except for the difference that the film insert, which provides the outer shell 16, is now preformed. This means that the two films forming the outer shell 16 are initially preformed before the installation in the battery arrangement 34, for example during the production of the intercell cooling element 12, and are, for example, slightly bulged. The two bulged films can then be joined together in the edge area to provide the outer shell 16 and then the spacer element arrangement 20 can be arranged or attached in the corresponding edge areas. The result of this is that when the intercell cooling element 12 is arranged between two cells 10a, 10b, the outer sides 26a, 26b adjoin the cell sides 40 of the cells 10a, 10b facing toward them, even if the interior 38 of the outer shell 16 is not yet filled with a coolant. Pressure and inflation of the outer shell 16 is therefore not necessary to bring the outer sides 26a, 26b of the outer shell 16 into contact with the cell sides 40.

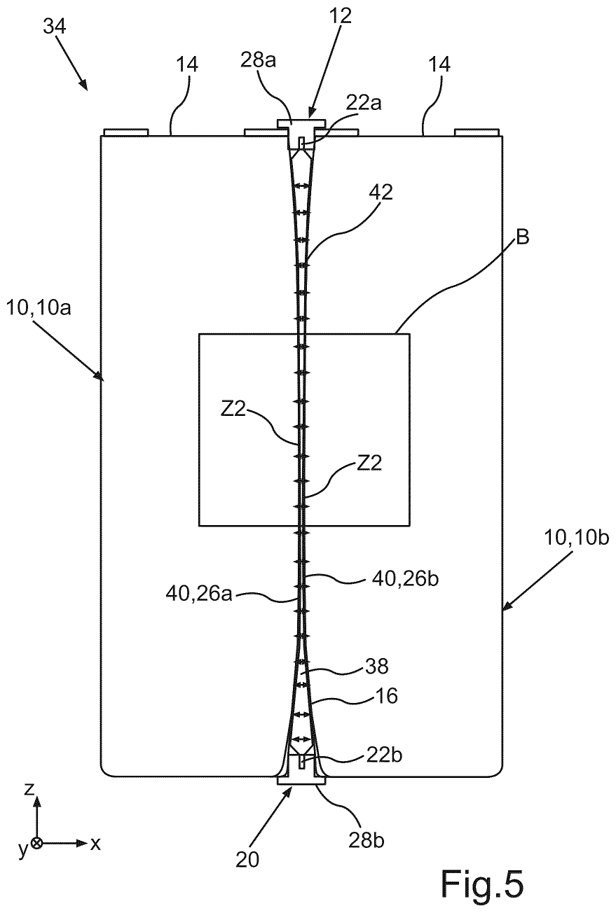

FIG. 5 shows a schematic representation of a battery arrangement 34, which can be designed in particular as described for FIG. 3 or FIG. 4, according to a further exemplary embodiment of the invention, wherein the battery arrangement 34 is now shown in a state in which the cells 10a, 10b are at least partially swollen. As a result, they are bulged in a central area in relation to the y direction and z direction. It can also be clearly seen that the cell swelling is not or hardly noticeable in the edge area R1, R2, in which the spacer elements 28a, 28b, and the optional further ones 30a, 30b analogously, are arranged.

The arrows 42 are intended to illustrate the clinging of the outer sides 26a, 26b of the outer shell 16 to the cell sides 40.

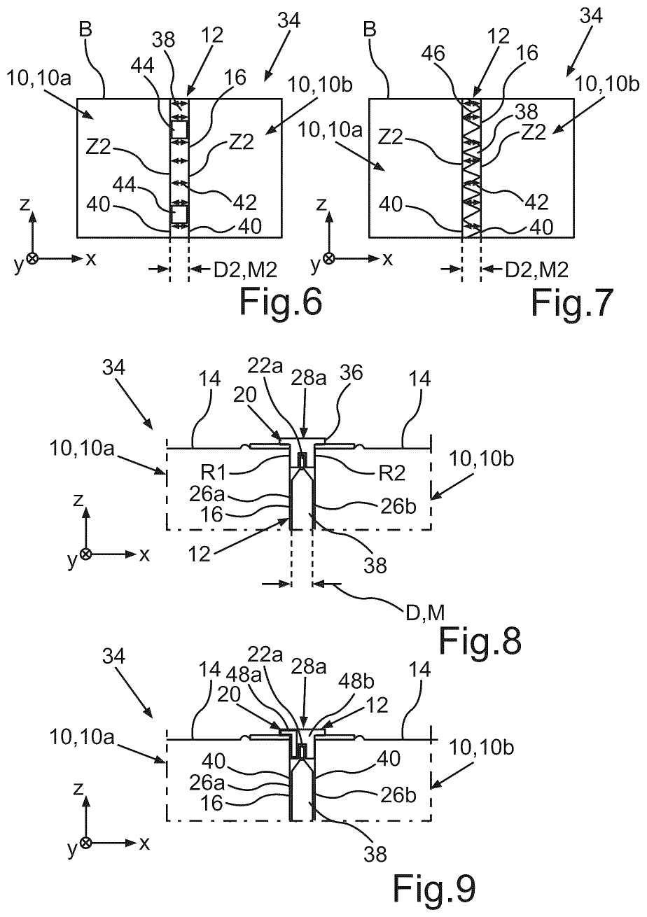

In order to additionally prevent the outer shell 16 from being flattened in the central area Z when the cells 10a, 10b are very strongly swollen, further measures can also be taken. In particular, buffer elements can also be arranged in the interior 38, as will be described in more detail below. For this purpose, an area B is schematically illustrated in FIG. 5, which is shown enlarged in FIG. 6 according to a first exemplary embodiment and is shown enlarged in FIG. 7 according to a further exemplary embodiment. According to the example shown in FIG. 6, multiple spatially separated buffer elements 44 are now arranged in the interior 38 of the outer shell 16. These can be arranged, for example, on the inner sides of the outer shell 16, which therefore face toward the interior 38. FIG. 6 shows, for example, these buffer elements 44, which can be designed to be compressible, for example, in a maximally compressed state. In this state, they have, for example, a second thickness D2, which defines a second minimum thickness M2 in the central area Z2 of the cell sides 40. The central area Z2 of the cell sides 40 can correspond to the central area Z of the adjoining intercell cooling element 12. These buffer elements 44 can also only come into contact with the opposite inner side of the outer shell 16, for example, when the distance between the two inner sides of the outer shell 16 falls below a certain distance. If the buffer elements 44 are rigid, this minimum distance corresponds to the thickness D2 of the buffer elements 44 or to twice the thickness D2 of such a buffer element when two buffer elements 44 meet one another.

It can be provided that such buffer elements 44 are arranged spatially distributed and separated from one another over the entire interior 38 on the inner sides of the outer shell 16. However, it can also be provided that these are arranged only in a partial area of the interior 38 that comprises the middle of the interior 38 with respect to the y and z directions, for example only in the middle or centrally or a small area around this middle.

FIG. 7 shows a further example of the design of such buffer elements in the form of a lattice structure 46, which can be arranged within the interior 38. In particular, such a lattice structure can be designed as a three-dimensional lattice structure 46. Such a lattice structure 46 is preferably formed as a regular lattice or having regular lattice structures, which can also vary in size, but not randomly. Unlike, for example, a porous material having randomly varying pore sizes, with a regular lattice structure 46 it can be ensured that no excessively high contact pressures occur locally. As a result, a significantly more uniform distribution of force over the adjoining cell surfaces 40 can be provided. The lattice structure 46, in particular if it is designed as a three-dimensional lattice 46, thus also allows the coolant to continue to flow through the interior 38 even in the compressed state of the outer shell 16. At the same time, such a lattice structure optionally provides a certain compressibility in the x-direction and this also allows a certain minimum thickness M2, which can be defined by the minimum compressed thickness D2 of the lattice structure 46, to be specified around the central area Z2 of the cells or cell sides 40.

The flexible geometry of the cooling plate, that is to say the outer shell 16, makes it possible to accommodate the swelling of the battery cells 10a, 10b. The cells remain in position and the forces within a module remain constant. The cell 10a, 10b can be partially supported by additional buffers, for example like the buffers 44, which are shown in FIG. 6, inside the artificial outer shell 16, that is in the interior 38 thereof, and complete compression of the cooling plate, that is to say the outer shell 16, can be prevented, in particular also in the central area Z of the intercell cooling element 12. By way of integrated 3D lattice structures 46, as shown in FIG. 7, which can in particular be manufactured from metal and/or plastic, within the artificial, that is to say the outer shell 16, planar support of the cells 10a, 10b can be provided and thus a complete compression of the cooling plate or outer shell 16 can be prevented.

FIG. 8 shows a schematic representation of the battery arrangement 34 in the area of a spacer element section 28a. There are also various design options for this spacer element section 28a, and analogously also for all other optional spacer element sections 28b, 30a, 30b explained. As already mentioned, such a spacer element section can, for example, be designed as an injection molding around the edge 22a and can thus be designed as a one-piece plastic part, as shown in FIG. 8.

FIG. 9 shows a schematic representation of the battery arrangement 34 or a part thereof, again in the area of the spacer element section 28a, which in this example is now designed in two parts. This has a first section part 48a and a second section part 48b. The edge 22a of the outer shell 16 is inserted between these section parts 48a, 48b and clamped between these section parts 48a, 48b. The section parts 48a, 48b can therefore first be manufactured, for example also in an injection molding process, and then they can be arranged against one another clamping around the edge 22a. Optionally, these can also be glued together or joined together in some other way. The connection of the section parts 48a, 48b can generally be accomplished by gluing, heat caulking, clipping, or a similar process.

Overall, the examples show how the invention can provide intercell cooling with a flexible heat sink and measures against swelling. The heat sink can consist of two glued or welded films or comprise those that form the outer shell described above. The heat sink can be mounted in a frame, which is provided in particular by the spacer element arrangement. This frame can be injection-molded or consist of two parts that are joined together. The circumferential or locally interrupted frame also offers the advantage that the sealing seams, i.e., the joints in the area of the film outer edges, are stabilized and thereby higher strengths are achieved in relation to the changing loads over the lifetime. The frame or, in general, the spacer element arrangement is simultaneously used as a spacer element when assembling the cells in the module or cell stack in the overall system. The distance between the cells can be adjusted via the thickness of the frame and thus a defined free space for swelling of the cells can be generated. When swelling, the flexible heat sink can be deformed and follow the changing cell geometry over its service life. Inserted buffer elements or structures can additionally prevent the heat sink from being completely compressed due to the swelling of the cells. These inserted elements also offer the possibility of optimizing the flow behavior within the heat sink. These structures can be solid, compressible, or made of a multi-component material in order to be able to absorb swelling forces. Overall, this can provide functional integration and a reduction in the complexity of a high-voltage battery by combining the intercell separating elements and battery cooling. Further cell separating elements to be arranged between the cells can therefore be omitted. An increase in cooling performance is made possible by increasing the number of connected cooling surfaces, as well as a cost reduction by eliminating expensive thermal pastes for thermal connection. This also makes it possible to reduce costs by eliminating insulation material between the cells to prevent thermal propagation.

1. An Intercell cooling element for arrangement between two battery cells, comprising
a flexible outer shell which encloses an interior, has a coolant supply connection for supplying a coolant into the interior, and has a coolant discharge connection for discharging a coolant from the interior;
wherein the outer shell has a first outer side for arrangement on a first battery cell, and
has a second outer side opposite to the first outer side for arrangement on a second battery cell,
wherein the first and second outer sides adjoin one another on outer edges of the outer shell;
wherein a spacer element arrangement which has at least two incompressible first spacer element sections to provide a minimum distance defined by a thickness of the first spacer element sections between a first edge area of the first battery cell and a second edge area of the second battery cell when the intercell cooling element is arranged as intended between the first and second battery cells,
wherein one of the at least two first spacer element sections is arranged on at least two first outer edges of the outer shell of the intercell cooling element which are opposite to one another with respect to a first direction.

2. The intercell cooling element according to claim 1, wherein the first two spacer element sections are constructed as two non-contiguous separate first spacer bars, in particular wherein none of the spacer element sections are arranged on two second outer edges of the outer shell located opposite in relation to a second direction and/or the coolant supply connection and the coolant discharge connection are arranged on at least one of the two second outer edges or in at least one of two outer edge areas of the outer shell that adjoin the two second outer edges.

3. The intercell cooling element according to claim 1, wherein the spacer element arrangement is composed of bar-shaped spacer element sections, which, in addition to the first spacer element sections, comprise at least two second incompressible spacer element sections, which are arranged on two second outer edges of the outer shell opposite with respect to a second direction, wherein the spacer element arrangement has at least one through opening or interruption through which the coolant supply connection and the coolant discharge connection are led to the outside.

4. The intercell cooling element according to claim 1, wherein the outer shell is formed from at least one foil, in particular from a metal foil.

5. The intercell cooling element according to claim 1, wherein the spacer element arrangement is made of or comprises a plastic or a fiber-reinforced plastic.

6. The intercell cooling element according to claim 1, wherein the intercell cooling element has at least one buffer element arranged in the interior to provide a second minimum distance, defined by a second thickness of the buffer element, between a first central area the first battery cell and a second central area of the second battery cell when the intercell cooling element is arranged between the first and second battery cells.

7. A battery arrangement having at least two battery cells and an intercell cooling element according to claim 1, which is arranged between the two battery cells.

8. A motor vehicle having a battery arrangement according to claim 7.

9. A method for producing an intercell cooling element for arrangement between two battery cells,
wherein the intercell cooling element is provided, which has a flexible outer shell which encloses an interior, has a coolant supply connection for supplying a coolant into the interior, and has a coolant discharge connection for discharging a coolant from the interior;
wherein the outer shell has a first outer side for arrangement on a first battery cell, and
has a second outer side opposite to the first outer side for arrangement on a second battery cell, and
wherein the first and second outer sides adjoin one another on outer edges of the outer shell;
wherein at least two incompressible first spacer element sections are provided to provide a minimum distance, defined by a thickness of the first spacer element sections between a first edge area of the first battery cell and a second edge area of the second battery cell, when the intercell cooling element is arranged as intended between the first and second battery cells, on at least two opposing first outer edges of the outer shell of the intercell cooling element.

10. The method according to claim 9, wherein
the at least two incompressible first spacer element sections are provided on the at least two opposing first outer edges of the outer shell in that the first spacer element sections are injection molded onto the at least two first outer edges in an injection molding process on the first outer edges; or
the first spacer element sections are designed in two parts and each have a first and second section part, wherein the first spacer element sections are provided on the at least two opposing first outer edges of the outer shell in that one of the at least two opposing first outer edges is arranged between a first and second section part, and in particular is clamped between them.

11. The intercell cooling element according to claim 2, wherein the spacer element arrangement is composed of bar-shaped spacer element sections, which, in addition to the first spacer element sections, comprise at least two second incompressible spacer element sections, which are arranged on two second outer edges of the outer shell opposite with respect to a second direction, wherein the spacer element arrangement has at least one through opening or interruption through which the coolant supply connection and the coolant discharge connection are led to the outside.

12. The intercell cooling element according to claim 2, wherein the outer shell is formed from at least one foil, in particular from a metal foil.

13. The intercell cooling element according to claim 3, wherein the outer shell is formed from at least one foil, in particular from a metal foil.

14. The intercell cooling element according to claim 2, wherein the spacer element arrangement is made of or comprises a plastic or a fiber-reinforced plastic.

15. The intercell cooling element according to claim 3, wherein the spacer element arrangement is made of or comprises a plastic or a fiber-reinforced plastic.

16. The intercell cooling element according to claim 4, wherein the spacer element arrangement is made of or comprises a plastic or a fiber-reinforced plastic.

17. The intercell cooling element according to claim 2, wherein the intercell cooling element has at least one buffer element arranged in the interior to provide a second minimum distance, defined by a second thickness of the buffer element, between a first central area the first battery cell and a second central area of the second battery cell when the intercell cooling element is arranged between the first and second battery cells.

18. The intercell cooling element according to claim 3, wherein the intercell cooling element has at least one buffer element arranged in the interior to provide a second minimum distance, defined by a second thickness of the buffer element, between a first central area the first battery cell and a second central area of the second battery cell when the intercell cooling element is arranged between the first and second battery cells.

19. The intercell cooling element according to claim 4, wherein the intercell cooling element has at least one buffer element arranged in the interior to provide a second minimum distance, defined by a second thickness of the buffer element, between a first central area the first battery cell and a second central area of the second battery cell when the intercell cooling element is arranged between the first and second battery cells.

20. The intercell cooling element according to claim 5, wherein the intercell cooling element has at least one buffer element arranged in the interior to provide a second minimum distance, defined by a second thickness of the buffer element, between a first central area the first battery cell and a second central area of the second battery cell when the intercell cooling element is arranged between the first and second battery cells.
